(19) United States
(12) Patent Application Publication
(10) Pub. No.: US 2025/0019502 A1
(43) Pub. Date: Jan. 16, 2025

(54) PREPARING METHOD OF POLYMER POWDER FOR BINDER AND BINDER COMPOSITION

(71) Applicant: KOREA KUMHO PETROCHEMICAL CO., LTD., Seoul (KR)

(72) Inventors: June PARK, Seoul (KR); Bona CHOI, Seoul (KR); Wonyeong RYU, Seoul (KR)

(73) Assignee: KOREA KUMHO PETROCHEMICAL CO., LTD., Seoul (KR)

(21) Appl. No.: 18/769,567

(22) Filed: Jul. 11, 2024

(30) Foreign Application Priority Data
Jul. 12, 2023 (KR) 10-2023-0090450

(51) Int. Cl. C08J 3/12; C08F 297/04; C08J 3/07

(52) U.S. Cl. CPC C08J 3/122; C08F 297/04; C08J 3/07; C08J 2353/02

(57) ABSTRACT

A method of preparing polymer powder which is able to serve as a binder for a particulate material through dry mixing, and a binder composition including the polymer powder are disclosed.

### CROSS-REFERENCE TO RELATED APPLICATION

This application claims priority to and the benefit of Korean Patent Application No. 10-2023-0090450, filed on Jul. 12, 2023, the disclosure of which is incorporated herein by reference in its entirety.

### BACKGROUND

### 1. Field of the Invention

The present disclosure relates to a method of preparing polymer powder for a binder, and a binder composition.

### 2. Discussion of Related Art

Traditionally, binders have been used to adhere various particulate maetrials to form a bonding structure. Examples of polymer binders include polyvinylidene fluoride (PVDF), polytetrafluoroethylene (PTFE), carboxymethyl cellulose (CMC), and the like.

In general, a binder is used by mixing it with a bonding material in a solvent, applying the mixture, and then removing the solvent. Since the process of removing the solvent takes a lot of time, technology development for binders that can be applied without a solvent is required.

Particularly, it is known that PTFE binders can be nanofiberized simply by mixing them without a solvent. However, when PTFE materials are applied, there are problems such as side reactions may occur depending on the application.

In addition, when conventional binders are applied in a dry process, problems such as insufficient adhesion or degraded product quality due to dispersibility issues may arise.

Therefore, there is a need to develop a binder composition that can achieve adhesion and sufficient strength through dry mixing alone.

### SUMMARY OF THE INVENTION

The description in the present specification was created in consideration of the above-described problems of the related art, and the present disclosure is directed to providing a method of preparing polymer powder that is applicable as a binder without a separate solvent, and a binder composition.

According to one aspect, there is provided a method of preparing polymer powder for a binder, which includes steps of (a) preparing a polymer solution in which a polymer including two or more blocks is dissolved or dispersed in an organic solvent; (b) preparing a polymer emulsion by mixing the polymer solution with an emulsifier and an inorganic solvent and then removing the organic solvent; and (c) preparing particulate polymer powder by removing the inorganic solvent from the polymer emulsion, wherein the polymer powder has an average particle size of 1 to 50 μm.

In an embodiment, the mixing of step (b) may be performed by spraying the polymer solution into the inorganic solvent in the presence of the emulsifier.

In an embodiment, the mixing of step (b) may be performed by spraying the inorganic solvent into the polymer solution in the presence of the emulsifier.

In an embodiment, in the polymer emulsion, the polymer may be dispersed in the form of spherical particles having an average particle size of 50 to 500 nm in the inorganic solvent.

In an embodiment, step (c) may be performed by at least one process selected from the group consisting of hot air drying, infrared drying, ultraviolet drying, microwave drying, spray drying, stripping drying, vacuum drying, natural drying, and adsorption drying.

According to another aspect, there is provided a binder composition including polymer powder for a binder, wherein the polymer powder includes two or more blocks and has an average particle size of 1 to 50 μm, and when the polymer powder is subjected to dry mixing with a particulate material, polymer particles dissociate and bind to at least a portion of the surface of the particulate material.

In an embodiment, the polymer may be a block copolymer including a structural unit derived from an aromatic vinyl monomer and a structural unit derived from a conjugated diene-based monomer.

In an embodiment, the structural unit derived from an aromatic vinyl monomer may be included in an amount of 10 to 50 parts by weight based on 100 parts by weight of the polymer. In an embodiment, the polymer may have a weight average molecular weight of 5,000 to 2,000,000 g/mol.

In an embodiment, the polymer may be a linear polymer.

In an embodiment, the polymer may have a degree of branching of 9 or less.

In an embodiment, the composition may not include a solvent.

### DESCRIPTION OF DRAWINGS

FIG. 1 shows a schematic illustration of a polymer powder (100) according to one specific example of the present disclosure being dry mixed with a particulate material (200) and dissociated;

FIG. 2 shows a photograph of polymer particles dispersed in an emulsion when manufacturing a polymer powder according to another specific example of the present disclosure;

FIGS. 3A and 3B show photographs of the particle size of a polymer dispersed in an emulsion and a particulate powder obtained by drying the polymer powder according to another specific example of the present disclosure;

FIGS. 4A and 4B show photographs of the particle size of a particulate powder manufactured according to another specific example of the present disclosure.

### DETAILED DESCRIPTION OF EXEMPLARY EMBODIMENTS

Hereinafter, an aspect of the present specification will be described with reference to specific embodiments. However, the description in the present specification may be implemented in various different forms, and therefore is not limited to the embodiments described herein. Also, to clearly explain an aspect of the present specification, matters widely known in the technical field will be omitted.

Throughout this specification, when it is said that a certain part is “connected” to another part, this means that the certain part is not only “directly connected” to the other part but also “indirectly connected” to the other part through another member interposed between the two parts. Also, when it is said that a certain part “includes” a certain element, this means that the certain part may further include, instead of excluding, another element unless particularly indicated otherwise.

When a numerical value is presented in this specification, the value has the precision of significant digits provided in accordance with the standard rules in chemistry for significant digits unless its specific range is stated otherwise. For example, the numerical value 10 includes the range of 5.0 to 14.9 and the numerical value 10.0 includes the range of 9.50 to 10.49.

As used herein, the term “structural unit” refers to a repeating structure derived from a specific monomer in a polymer chain. For example, a structural unit derived from 1,3-butadiene may include a trans-1,4 structure, a cis-1,4 structure, a vinyl-1,2 structure, and the like.

As used herein, the term “block” refers to a region in which monomer-derived structural units are arranged in a specific order in a copolymer formed by polymerization of two or more monomers. For example, in a copolymer including structural units A and B, block A may be represented by “A-A-A-A- . . . ” or “ . . . -A-A-A-A- . . . ,” and block B may be represented by “B-B-B-B- . . . ” or “ . . . -B-B-B-B- . . . ”.

Hereinafter, one aspect of the present specification will be described in detail.

### Method of Preparing Polymer Powder for Binder

A method of preparing polymer powder for a binder according to one aspect includes steps of: (a) preparing a polymer solution in which a polymer including two or more blocks is dissolved or dispersed in an organic solvent; (b) preparing a polymer emulsion by mixing the polymer solution with an emulsifier and an inorganic solvent and then removing the organic solvent; and (c) preparing particulate polymer powder by removing the inorganic solvent from the polymer emulsion, wherein the polymer powder has an average particle size of 1 to 50 μm.

Step (a) may be intended to prepare a polymer solution in which a polymer is dissolved or dispersed in an organic solvent. In this case, the polymer may include two or more blocks.

In this case, the polymer solution includes both a polymer dissolved in an organic solvent and a polymer not dissolved but dispersed in an organic solvent. When a polymer is dissolved in an organic solvent, polymer chains may be present in a dissociated state, not an entangled state. On the other hand, in the case of the polymer solution in which a polymer is dispersed in an organic solvent, discontinuous-phase particles formed by entangling polymer chains may be present in a continuous-phase organic solvent.

The organic solvent in which a polymer is dissolved or dispersed may be, for example, at least one selected from the group consisting of n-pentane, iso-pentane, n-hexane, n-heptane, iso-heptane, n-octane, iso-octane, cyclohexane, methylcyclopentane, benzene, toluene, xylene, and ethylbenzene, but the present disclosure is not limited thereto.

As the polymer solution, a solution in which an already prepared polymer is dissolved or dispersed in an organic solvent, or a solution in which a polymer produced after monomers are polymerized in an organic solvent is dissolved or dispersed in the organic solvent may be used.

The content of the organic solvent may be, based on 100 parts by weight of the polymer, 20 to 2,000 parts by weight, for example, 20 parts by weight, 100 parts by weight, 150 parts by weight, 200 parts by weight, 250 parts by weight, 300 parts by weight, 350 parts by weight, 400 parts by weight, 450 parts by weight, 500 parts by weight, 550 parts by weight, 600 parts by weight, 650 parts by weight, 700 parts by weight, 750 parts by weight, 800 parts by weight, 850 parts by weight, 900 parts by weight, 950 parts by weight, 1,000 parts by weight, 1,050 parts by weight, 1,100 parts by weight, 1,150 parts by weight, 1,200 parts by weight, 1,250 parts by weight, 1,300 parts by weight, 1,350 parts by weight, 1,400 parts by weight, 1,450 parts by weight, 1,500 parts by weight, 1,550 parts by weight, 1,600 parts by weight, 1,650 parts by weight, 1,700 parts by weight, 1,750 parts by weight, 1,800 parts by weight, 1,850 parts by weight, 1,900 parts by weight, 1,950 parts by weight, or 2,000 parts by weight or in a range between two of these values, but the present disclosure is not limited thereto.

As a method of preparing a polymer solution by polymerizing monomers in an organic solvent, radical polymerization, cationic polymerization, anionic polymerization, or the like may be used.

Radical polymerization is a method of polymerizing monomers using free radicals generated from an initiator and the like. In general, radical polymerization is used to polymerize monomers having carbon-carbon double bonds. A radical polymerization initiator is easily decomposed to form radicals. The initiator radicals react with monomers to form monomer radicals. Then, the monomer radicals combine with other monomers, and thus a polymer chain grows. Finally, polymerization is terminated by a termination reaction in which radicals are combined.

In order to form a uniform polymer through radical polymerization, living radical polymerization such as RAFT polymerization, ATRP polymerization, NMP polymerization, TERP polymerization, and the like may be utilized. When living radical polymerization is used, the properties of a polymer, such as the degree of polymerization and molecular weight, may be controlled by adjusting conditions such as reaction time, monomer concentration, and the like. Also, when living radical polymerization is used, even after polymerization is terminated, the activity at the end of the chain may remain, making it easy to prepare a block copolymer.

Cationic polymerization is generally performed under acidic conditions and used to polymerize anionic monomers having an electron-donating substituent such as carboxylic acid, acrylic acid, or styrene. The reaction is initiated by reacting an initiator such as Friedel-Crafts catalysts or Lewis acids with a co-initiator such as water or organic acids to form an ion pair. As a monomer is added to the initiator ion pair, a polymer grows, and when the reaction is terminated, a cationic polymer may be obtained. Cationic polymerization is known to be capable of controlling the molecular weight, the molecular weight distribution, or the polymer structure by adjusting the livingness according to the initiator/co-initiator system.

In anionic polymerization, the active sites at the end of a polymer often repel each other. Therefore, since there is no termination by a bimolecular reaction and little chain transfer, anionic polymerization is known to be the most suitable for living polymerization. In the case of anionic polymerization, polymerization is initiated by mixing monomers in a solvent and then adding an anionic initiator. Then, as the initiator continuously combines with the monomer, a polymer grows, and a polymerization terminator is added to terminate the reaction. In this case, the properties of a polymer may be controlled by adjusting the microstructure of a polymer by varying the catalytic system used.

When the above-described polymerization methods are used for solution polymerization in an organic solvent, a polymer solution in which a polymer is dissolved or dispersed may be prepared. Solution polymerization may be performed in the reaction system in which a chain transfer agent or the like is added to an organic solvent in which monomers and an initiator are dissolved if necessary. When solution polymerization is used, the heat of reaction, temperature, and the like may be easily controlled. After the reaction is terminated, a polymer may be present in a dissolved or dispersed state in an organic solvent.

As the polymer, a polymer including two or more blocks may be used. The polymer may include at least one each of a hard segment block and a soft segment block. When the proportion of the hard segment block in the polymer increases, hardness and adhesive strength may increase, and viscosity may decrease. On the other hand, when the proportion of the soft segment block in the polymer increases, elasticity may increase.

For example, as the polymer, a block copolymer including a structural unit derived from an aromatic vinyl monomer and a structural unit derived from a conjugated diene-based monomer may be used, but the present disclosure is not limited thereto.

Here, at least a portion of the structural unit derived from an aromatic vinyl monomer may form a hard segment block. When the content of the structural unit derived from an aromatic vinyl monomer in the block copolymer is high, T_{g} may increase. Also, the structural unit derived from the aromatic vinyl monomer may serve to maintain a network structure after the formation of the network structure.

In an example, the content of the structural unit derived from an aromatic vinyl monomer may be 12.5 wt % or more, for example, 12.5 wt %, 13 wt %, 13.5 wt %, 14 wt %, 14.5 wt %, 15 wt %, 15.5 wt %, 16 wt %, 16.5 wt %, 17 wt %, 17.5 wt %, 18 wt %, 18.5 wt %, 19 wt %, 19.5 wt %, 20 wt %, 20.5 wt %, 21 wt %, 21.5 wt %, 22 wt %, 22.5 wt %, 23 wt %, 23.5 wt %, 24 wt %, 24.5 wt %, 25 wt %, 25.5 wt %, 26 wt %, 26.5 wt %, 27 wt %, 27.5 wt %, 28 wt %, 28.5 wt %, 29 wt %, 29.5 wt %, 30 wt %, 30.5 wt %, 31 wt %, 31.5 wt %, 32 wt %, 32.5 wt %, 33 wt %, 33.5 wt %, 34 wt %, 34.5 wt %, 35 wt %, 35.5 wt %, 36 wt %, 36.5 wt %, 37 wt %, 37.5 wt %, 38 wt %, 38.5 wt %, 39 wt %, 39.5 wt %, 40 wt %, 40.5 wt %, 41 wt %, 41.5 wt %, 42 wt %, 42.5 wt %, 43 wt %, 43.5 wt %, 44 wt %, 44.5 wt %, 45 wt %, 45.5 wt %, 46 wt %, 46.5 wt %, 47 wt %, 47.5 wt %, 48 wt %, 48.5 wt %, 49 wt %, 49.5 wt %, 50 wt %, or 50 wt % or more, but the present disclosure is not limited thereto.

The aromatic vinyl monomer may be at least one selected from the group consisting of styrene, α-methylstyrene, 2-methylstyrene, 3-methylstyrene, 4-methylstyrene, 2,4-dimethylstyrene, 2,4-diisopropylstyrene, 4-propylstyrene, 4-cyclohexylstyrene, 4-(p-methylphenyl)styrene, 5-tert-butyl-2-methylstyrene, tert-butoxystyrene, 2-tert-butylstyrene, 3-tert-butylstyrene, 4-tert-butylstyrene, N,N-dimethylaminoethylstyrene, 1-vinyl-5-hexylnaphthalene, 1-vinylnaphthalene, divinylnaphthalene, divinylbenzene, trivinylbenzene, vinylbenzyldimethylamine, (4-vinylbenzyl)dimethylaminoethylether, vinylpyridine, vinylxylene, diphenylethylene, diphenylethylene including a tertiary amine, and styrene including a primary, secondary, or tertiary amine, but the present disclosure is not limited thereto.

Meanwhile, at least a portion of the structural unit derived from the conjugated diene-based monomer may form a soft segment block. In the block copolymer, the soft segment block may provide a function as a physical crosslinking agent by forming a three-dimensional network structure. Also, since the soft segment block has resistance to deformation, it may maintain adhesive strength even when a structural change occurs due to an external force when applied as a binder.

The conjugated diene-based monomer may be at least one selected from the group consisting of 1,3-butadiene, isoprene, 2,3-dimethyl-1,3-butadiene, 1,3-pentadiene, 1,3-hexadiene, 2-phenyl-1,3-butadiene, 3-methyl-1,3-pentadiene, 2-chloro-1,3-butadiene, 3-butyl-1,3-octadiene, and octadiene, but the present disclosure is not limited thereto.

In addition, as the polymer, a polymer with high linearity may be used. The linear polymer may have a low melt flow index, high solution viscosity, high tensile strength, and a high elongation rate compared to a branched polymer. When the linear polymer is applied as a binder for dry mixing, the polymer may come in linear contact with bonding targets in a dissociated state. Particularly, when the polymer including both the hard segment block and the soft segment block comes in linear contact, they may maintain adhesion by forming a linear network even when two or more bonding targets move apart.

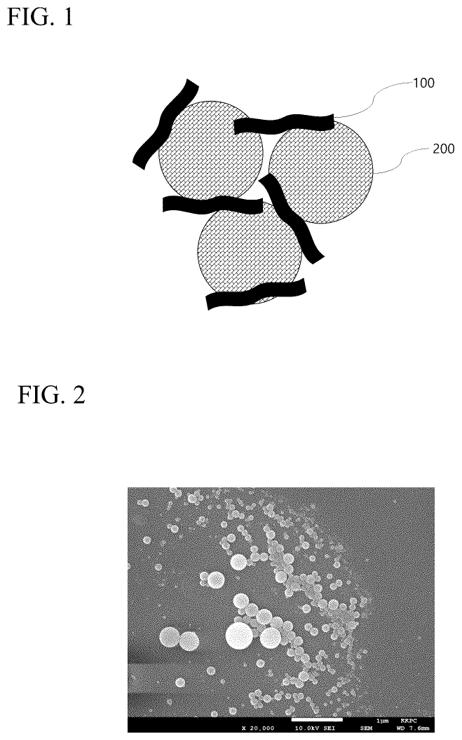

For example, FIG. 1 shows a simplified illustration of an example of linear contact in a dissociated state when polymer powder (100) is dry mixed with particulate matter (200).

Step (b) may be intended to prepare a polymer emulsion in which the polymer dissolved or dispersed in the organic solvent is dispersed in the form of particles with a small average particle size by emulsifying the polymer in an inorganic solvent in the presence of an emulsifier. In other words, in step (b), the polymer may be dispersed in an inorganic solvent, or a phase inversion phenomenon in which the polymer dispersed in the organic solvent becomes unstable and disperses in an inorganic solvent may occur.

In this case, the polymer may be dispersed in the form of discontinuous-phase small particles surrounded by an emulsifier in a continuous-phase inorganic solvent. In this process, the entanglement of polymer chains is minimized, and thus the polymer may have a small average particle size.

As a method of emulsifying the polymer in an inorganic solvent, there is a method of mixing an organic phase and an inorganic phase in the presence of an emulsifier using an emulsification device or dispersion device. Here, the emulsifier may be added to at least of the polymer solution and the inorganic solvent or added while they are mixed.

Meanwhile, when the polymer is dispersed using a high-pressure sprayer, a polymer emulsion having a relatively small particle size may be prepared. In this case, the processing conditions of the high-pressure sprayer are not particularly limited, and a temperature, time, or pressure may be selected to reach a desired dispersion state.

In one example, the mixing of step (b) may be performed by spraying the polymer solution into the inorganic solvent in the presence of the emulsifier.

In another example, the mixing of step (b) may be performed by spraying the inorganic solvent into the polymer solution in the presence of the emulsifier.

The polymer may be present in the form of small spherical particles in the emulsion. When the polymer particles have a small average particle size, particulate polymer powder with a relatively small particle size may be prepared. The particulate polymer powder with a small particle size may have a large contact area due to its relatively large surface area when applied as a binder for dry mixing, and adhesive strength may be improved due to excellent dispersibility. In an example, in the polymer emulsion, the polymer may be dispersed in the form of spherical particles with an average particle size of 50 to 500 nm, for example, 50 nm, 75 nm, 100 nm, 125 nm, 150 nm, 175 nm, 200 nm, 225 nm, 250 nm, 275 nm, 300 nm, 325 nm, 350 nm, 375 nm, 400 nm, 425 nm, 450 nm, 475 nm, or 500 nm or in a range between two of these values in the inorganic solvent.

In this case, when the content of the emulsifier is excessively low, polymers are agglomerated, and thus an average particle size may increase. When the content of the emulsifier is excessive, the function as a binder may be hindered. For example, the content of the emulsifier may be, with respect to 100 parts by weight of the polymer, 0.1 to 50 parts by weight, for example, 0.1 parts by weight, 1 part by weight, 2.5 parts by weight, 5 parts by weight, 7.5 parts by weight, 10 parts by weight, 12.5 parts by weight, 15 parts by weight, 17.5 parts by weight, 20 parts by weight, 22.5 parts by weight, 25 parts by weight, 27.5 parts by weight, 30 parts by weight, 32.5 parts by weight, 35 parts by weight, 37.5 parts by weight, 40 parts by weight, 42.5 parts by weight, 45 parts by weight, 47.5 parts by weight, or 50 parts by weight or in a range between two of these values, but the present disclosure is not limited thereto.

As a non-limiting example, the emulsifier may be at least one selected from the group consisting of an anionic surfactant, a nonionic surfactant, a cationic surfactant, and an amphoteric surfactant. For example, the emulsifier may be at least one selected from the group consisting of sodium laurate, potassium laurate, sodium tetradecanoate, potassium tetradecanoate, sodium hexadecanoate, potassium hexadecanoate, sodium oleate, potassium oleate, sodium linoleate, potassium linoleate, sodium rosinate, potassium rosinate, sodium dodecylbenzenesulfonate, potassium dodecylbenzenesulfonate, sodium decylbenzenesulfonate, potassium decylbenzenesulfonate, sodium cetylbenzenesulfonate, potassium cetylbenzenesulfonate, alkyl sulfosuccinates such as sodium di(2-ethylhexyl)sulfosuccinate, potassium di(2-ethylhexyl)sulfosuccinate, sodium dioctylsulfosuccinate, and the like, sodium lauryl sulfate, potassium lauryl sulfate, sodium polyoxyethylene lauryl ether sulfate, potassium polyoxyethylene lauryl ether sulfate, sodium lauryl phosphate, and potassium lauryl phosphate, but the present disclosure is not limited thereto.

As the hydrophilic-lipophilic balance (HLB) value of the emulsifier is lower, the viscosity of the polymer emulsion may be high, and the average particle size may decrease. For example, the HLB value of the emulsifier may be 8 to 18, but the present disclosure is not limited thereto.

Step (c) may be intended to prepare particulate polymer powder, that is, polymer microparticles, with an average particle size of 1 to 50 μm by removing the inorganic solvent from the polymer emulsion with a small average particle size.

The average particle size of particulate polymer powder may be 1 to 50 μm, for example, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, or 50 μm or in a range between two of these values.

When a particulate polymer with a relatively small average particle size is applied as a binder, it may uniformly dispersed during dry mixing without using a solvent, or it may serve as a linear contact binder similarly to nanofibrillation. Also, the surface area relatively increases, and thus the contact area with a bonding target may increase.

Step (c) may be performed by at least one process selected from the group consisting of hot air drying, infrared drying, ultraviolet drying, microwave drying, spray drying, stripping drying, vacuum drying, natural drying, and adsorption drying.

In particular, when the inorganic solvent is removed using a spray drying process, microparticles with a relatively small size may be formed. For example, polymer powder having an average particle size of 10 μm or less may be prepared, but the present disclosure is not limited thereto.

### Binder Composition

A binder composition according to another aspect includes polymer powder for a binder, wherein the polymer powder includes two or more blocks and has an average particle size of 1 to 50 μm, and when the polymer powder is subjected to dry mixing with a particulate material, polymer particles dissociate and bind to at least a portion of the surface of the particulate material.

The polymer powder for a binder may have the above-described characteristics. Also, the polymer powder for a binder may be prepared by the above-described preparation method. Therefore, hereinafter, the description already described for the polymer powder for a binder will be omitted.

In an example, the polymer may be a block copolymer including a structural unit derived from an aromatic vinyl monomer and a structural unit derived from a conjugated diene-based monomer. In this case, two or more structural unit blocks derived from an aromatic vinyl monomer may be combined with a structural unit block derived from a conjugated diene-based monomer.

In the block copolymer, the content of the structural unit derived from the aromatic vinyl monomer may be, based on 100 parts by weight of the polymer, 10 to 50 parts by weight, for example, 10 parts by weight, 11 parts by weight, 12 parts by weight, 13 parts by weight, 14 parts by weight, 15 parts by weight, 16 parts by weight, 17 parts by weight, 18 parts by weight, 19 parts by weight, 20 parts by weight, 21 parts by weight, 22 parts by weight, 23 parts by weight, 24 parts by weight, 25 parts by weight, 26 parts by weight, 27 parts by weight, 28 parts by weight, 29 parts by weight, 30 parts by weight, 31 parts by weight, 32 parts by weight, 33 parts by weight, 34 parts by weight, 35 parts by weight, 36 parts by weight, 37 parts by weight, 38 parts by weight, 39 parts by weight, 40 parts by weight, 41 parts by weight, 42 parts by weight, 43 parts by weight, 44 parts by weight, 45 parts by weight, 46 parts by weight, 47 parts by weight, 48 parts by weight, 49 parts by weight, or 50 parts by weight or in a range between two of these values, but the present disclosure is not limited thereto.

It is generally known that the elasticity of a soft segment structure in a binder including a block copolymer provides adhesive strength, so as a hard segment structure increases, adhesive strength decreases. However, in the binder composition of the present disclosure, polymer powder for a binder, which has a high proportion of hard segment structures, is used. This polymer is more advantageous than a polymer having a high proportion of soft segment structures due to having high adhesive strength with a particulate material in dry mixing. Although the principle is not clearly known, the adhesive structure is rather destroyed due to the elasticity of the soft segment after dry mixing, and thus adhesive strength may be degraded.

The weight average molecular weight of the polymer may be 5,000 to 2,000,000 g/mol, for example, 5,000 g/mol, 10,000 g/mol, 15,000 g/mol, 20,000 g/mol, 25,000 g/mol, 30,000 g/mol, 35,000 g/mol, 40,000 g/mol, 45,000 g/mol, 50,000 g/mol, 55,000 g/mol, 60,000 g/mol, 65,000 g/mol, 70,000 g/mol, 75,000 g/mol, 80,000 g/mol, 85,000 g/mol, 90,000 g/mol, 95,000 g/mol, 100,000 g/mol, 150,000 g/mol, 200,000 g/mol, 250,000 g/mol, 300,000 g/mol, 350,000 g/mol, 400,000 g/mol, 450,000 g/mol, 500,000 g/mol, 550,000 g/mol, 600,000 g/mol, 650,000 g/mol, 700,000 g/mol, 750,000 g/mol, 800,000 g/mol, 850,000 g/mol, 900,000 g/mol, 950,000 g/mol, 1,000,000 g/mol, 1,050,000 g/mol, 1,100,000 g/mol, 1,150,000 g/mol, 1,200,000 g/mol, 1,250,000 g/mol, 1,300,000 g/mol, 1,350,000 g/mol, 1,400,000 g/mol, 1,450,000 g/mol, 1,500,000 g/mol, 1,550,000 g/mol, 1,600,000 g/mol, 1,650,000 g/mol, 1,700,000 g/mol, 1,750,000 g/mol, 1,800,000 g/mol, 1,850,000 g/mol, 1,900,000 g/mol, 1,950,000 g/mol, or 2,000,000 g/mol or in a range between two of these values.

When the weight average molecular weight of the polymer is excessively low, the polymer is present in a liquid phase at room temperature, which may not be suitable for serving as a binder for dry mixing. On the other hand, when the weight average molecular weight of the polymer is excessively high, adhesive strength may be degraded, or application as a binder may be difficult.

The weight average molecular weight may be determined by various measurement methods according to the type of polymer. For example, gel permeation chromatography using a polystyrene-based conversion method and the like may be utilized, but the present disclosure is not limited thereto.

The polymer of the binder composition may be a linear polymer. In an example, the polymer may have a degree of branching of 9 or less, 8 or less, 7 or less, 6 or less, 5 or less, 4 or less, 3 or less, 2.5 or less, 2 or less, or 1.5 or less, but the present disclosure is not limited thereto. Here, the degree of branching is expressed by a ratio of solution viscosity and Mooney viscosity, and the greater the linearity, the smaller the degree of branching. When a linear polymer is used, the above-described linear contact may be possible when applied as a binder for a particulate material.

The particulate powder may be metal particles, metal oxide particles, metal hydroxide particles, carbon-based particles, or the like. For example, the particulate powder may be carbon-based particles including carbon black, carbon nanotubes, and the like, silicon-based particles, silicon oxide-based particles including silica and the like, aluminum oxide-based particles, zirconium oxide-based particles, manganese oxide-based particles, nickel oxide-based particles, tin oxide-based particles, or the like, but the present disclosure is not limited thereto.

In addition, when a difference in the average particle size between the particulate powder and the polymer powder for a binder becomes excessively large, it may be difficult to disperse the polymer powder for a binder during dry mixing. In an example, the average particle size of the particulate powder may be 1 to 100 μm, for example, 1 μm, 2.5 μm, 5 μm, 7.5 μm, 10 μm, 12.5 μm, 15 μm, 17.5 μm, 20 μm, 22.5 μm, 25 μm, 27.5 μm, 30 μm, 32.5 μm, 35 μm, 37.5 μm, 40 μm, 42.5 μm, 45 μm, 47.5 μm, 50 μm, 52.5 μm, 55 μm, 57.5 μm, 60 μm, 62.5 μm, 65 μm, 67.5 μm, 70 μm, 72.5 μm, 75 μm, 77.5 μm, 80 μm, 82.5 μm, 85 μm, 87.5 μm, 90 μm, 92.5 μm, 95 μm, 97.5 μm, or 100 μm or in a range between two of these values, but the present disclosure is not limited thereto.

Unlike a conventional binder that exhibits adhesive strength only when the binder is applied in the form of a slurry in which the binder is dispersed in a solvent, the polymer powder for a binder according to the present disclosure may be used as a binder without a solvent by being subjected to dry mixing with particulate powder under heating and pressurization conditions. In an example, the composition may not include a solvent.

The dry mixing may be performed at 50° C. or higher, for example, 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., or 150° C. or in a range between two of these values, but the present disclosure is not limited thereto. The dry mixing may be performed at a temperature higher than T_{g}—25° C. of the polymer and lower than a thermal decomposition temperature.

Meanwhile, the pressurization conditions may vary depending on the types of polymer powder for a binder and particulate powder. For example, pressure may be applied so that 1 to 50 parts by volume are reached when the polymer powder for a binder and the particulate powder are pressurized based on 100 parts by volume before pressurization, but the present disclosure is not limited thereto.

The dry mixing may be performed by extrusion, pressing, and the like depending on the desired product form. For example, a molded body may be formed through roll pressing.

In addition, the content of the polymer powder for a binder may be, based on 100 parts by weight of the particulate powder, 3 to 15 parts by weight, for example, 3 parts by weight, 4 parts by weight, 5 parts by weight, 6 parts by weight, 7 parts by weight, 8 parts by weight, 9 parts by weight, 10 parts by weight, 11 parts by weight, 12 parts by weight, 13 parts by weight, 14 parts by weight, or 15 parts by weight or in a range between two of these values. Outside the above range, adhesive strength may be insufficient, or the effect of the particulate powder may be hindered.

When a particulate polymer with a relatively small average particle size is applied as a binder, it may be uniformly dispersed during dry mixing without using a solvent, or it may serve as a linear contact binder similarly to nanofibrillation. Also, the surface area relatively increases, and thus the contact area with a bonding target may increase.

In the structure prepared by dry mixing the above-described binder composition with a particulate material, the dissociated polymer may bond to at least a portion of the surface of the particulate material through linear contact. Here, the bonding may be achieved through various types of bond such as a hydrogen bond, van der Waals bond, a covalent bond, and the like.

Hereinafter, examples of the present specification will be described in further detail. However, the following experimental results are obtained from only a few selected examples of the disclosure, and the scope and contents of the present specification should not be interpreted as being reduced or limited by the few selected examples. The effects of each of the various embodiments of the present specification, which are not explicitly set forth below, will be described in detail in relevant sections.

### EXAMPLE 1

Anionic polymerization was performed in cyclohexane using a butyllithium initiator to prepare a polymer solution in which 100 parts by weight of a linear styrene-butadiene-styrene copolymer having a styrene content of 40.5 wt % and exhibiting a solution viscosity at 25° C. of 600 cps, a Shore-A (5 sec) hardness of 91, and a melt flow index at 200° C. and 5 kg of 11 g/10 min when 25 wt % thereof was dissolved in toluene was dissolved in 1,150 parts by weight of cyclohexane. In this case, a proportion of the branched structure of the copolymer was 5 wt % or less.

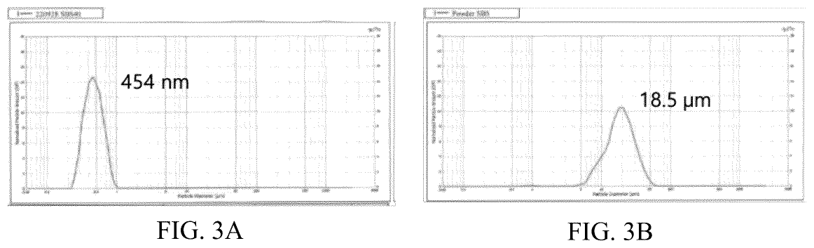

1,250 parts by weight of an aqueous emulsifier solution including sodium dodecylbenzene sulfonate in an amount of 5 parts by weight based on 100 parts by weight of the copolymer was prepared. The polymer solution was added to the aqueous emulsifier solution at room temperature and a discharge pressure of 300 kg/cm² using a high-pressure sprayer. Afterward, the resulting mixture was heated to 60° C., and then a pressure was reduced to remove the cyclohexane. Centrifugation was performed at 25° C. and 7,000 rpm to prepare a styrene-butadiene-styrene block copolymer emulsion having a solid content of 40%. The scanning electron microscope (SEM) image of polymer particles dispersed in the emulsion is shown in FIG. 2. The size of the polymer in the emulsion was measured and is shown in FIG. 3A, and the average particle size (d50) was measured to be 454 nm.

Moisture was removed from the emulsion using a hot air dryer set at 110° C. to prepare a particulate styrene-butadiene-styrene block copolymer powder. The particle size of the particulate powder was measured and is shown in FIG. 3B, and the average particle size (d50) was measured to be 18.5 μm.

### EXAMPLE 2

A styrene-butadiene-styrene block copolymer emulsion was prepared in the same manner as in Example 1.

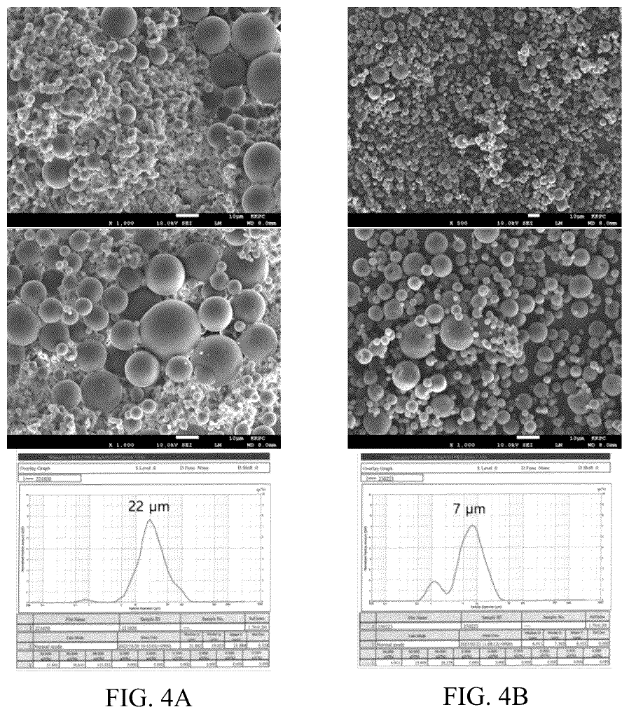

Moisture was removed from the emulsion using a hot air dryer set at 120° C. to prepare a particulate styrene-butadiene-styrene block copolymer powder. The SEM results and particle size measurement results of the particulate powder are shown in FIG. 4A. The average particle size (d50) of the particulate powder prepared in Example 2 was measured to be about 22 μm.

### EXAMPLE 3

A styrene-butadiene-styrene block copolymer emulsion was prepared in the same manner as in Example 1.

Moisture was removed from the emulsion while inputting 110° C. air as a transfer gas into a spray dryer, thereby preparing a binder in the form of particulate styrene-butadiene-styrene block copolymer powder. The SEM results and particle size measurement results of the particulate powder are shown in FIG. 4B. The average particle size (d50) of the particulate powder prepared in Example 3 was measured to be about 7 μm.

### COMPARATIVE EXAMPLE 1

A linear styrene-butadiene-styrene copolymer pellet (KUMHO PETROCHEMICAL; KTR-602) having a styrene content of 40.5 wt % and exhibiting a solution viscosity at 25° C. of 600 cps, a Shore-A (5 sec) hardness of 91, and a melt flow index at 200°° C. and 5 kg of 11 g/10 min when 25 wt % thereof was dissolved in toluene was prepared as a binder.

### COMPARATIVE EXAMPLE 2

A binder was prepared in the form of non-uniform particulate powder having an average particle size of 1 to 5 mm, which was prepared by mechanically grinding the linear styrene-butadiene-styrene copolymer prepared in Comparative Example 1.

### Preparation Examples and Comparative Preparation Examples

Each of the binders prepared in the examples and the comparative examples was subjected to dry mixing with Grade 1165 silica powder for tires without any separate solvent. Afterward, the resulting mixture was input into a roll press set at 80° C. or 120° C. to prepare a sample, and results thereof are shown in the following Table 1.

TABLE 1

| | | Binder | Molding | |
|---|---|---|---|---|
| | Type of | content | temperature | |
| Classification | binder | (wt %) | (° C.) | Moldability |
| Preparation | Example 1 | 3 | 80 | x |
| Example 1 | | | | |
| Preparation | Example 1 | 6 | 80 | x |
| Example 2 | | | | |
| Preparation | Example 1 | 12 | 80 | ∘ |
| Example 3 | | | | |
| Preparation | Example 1 | 6 | 120 | ⊚ |
| Example 4 | | | | |
| Preparation | Example 1 | 3 | 120 | ⊚ |
| Example 5 | | | | |
| Preparation | Example 1 | 3 | 120 | ⊚ |
| Example 6 | | | | |
| Preparation | Example 1 | 3 | 120 | ⊚ |
| Example 7 | | | | |
| Comparative | Comparative | 3 | 80 | x |
| Preparation | Example 1 | | | |
| Example 1 | | | | |
| Comparative | Comparative | 3 | 120 | x |
| Preparation | Example 1 | | | |
| Example 2 | | | | |
| Comparative | Comparative | 6 | 120 | x |
| Preparation | Example 1 | | | |
| Example 3 | | | | |
| Comparative | Comparative | 3 | 80 | x |
| Preparation | Example 2 | | | |
| Example 4 | | | | |
| Comparative | Comparative | 3 | 120 | x |
| Preparation | Example 2 | | | |
| Example 5 | | | | |
| Comparative | Comparative | 6 | 120 | Δ |
| Preparation | Example 2 | | | |
| Example 6 | | | | |

In Table 1, the case where molding was not possible was marked as ×, the case where molding was possible but the sample had an uneven surface or was easily damaged was marked as Δ, the case where molding was possible without any problem was marked as ○, and the case where molding was possible without any problems and the sample had excellent quality visually was marked as ⊚.

According to one aspect, polymer powder that is applicable as a binder through dry mixing due to having a small average particle size and a large surface area can be prepared.

However, it is to be understood that the effects of an aspect of the present specification is not limited to the above-described effect but include all effects deducible from the configuration described in the detailed description of the present specification or in the claims.

The foregoing description of the present specification is intended for illustrative purposes, and it will be understood by those skilled in the art to which the present disclosure pertains that the present disclosure can be easily modified in other specific forms without changing the technical spirit or essential features described in the present specification. Therefore, it should be understood that the embodiments described above are only exemplary in all aspects and not limiting. For example, each of the constituents described as being one combined entity may be implemented separately, and similarly, constituents described as being separate entities may be implemented in a combined form.

It should be understood that the scope of the present specification is defined by the following claims and that all changes or modifications derived from the meaning and scope of the claims and their equivalents are included in the scope of the present specification.

What is claimed is:

1. A method of preparing polymer powder for a binder, comprising the steps of:
(a) preparing a polymer solution in which a polymer including two or more blocks is dissolved or dispersed in an organic solvent;
(b) preparing a polymer emulsion by mixing the polymer solution with an emulsifier and an inorganic solvent and then removing the organic solvent; and
(c) preparing particulate polymer powder by removing the inorganic solvent from the polymer emulsion,
wherein the polymer powder has an average particle size of 1 to 50 μm.

2. The method of claim 1, wherein the mixing of the step (b) is performed by spraying the polymer solution into the inorganic solvent in the presence of the emulsifier.

3. The method of claim 1, wherein the mixing of the step (b) is performed by spraying the inorganic solvent into the polymer solution in the presence of the emulsifier.

4. The method of claim 1, wherein in the polymer emulsion, the polymer is dispersed in the form of spherical particles having an average particle size of 50 to 500 nm in the inorganic solvent.

5. The method of claim 1, wherein the step (c) is performed by at least one process selected from the group consisting of hot air drying, infrared drying, ultraviolet drying, microwave drying, spray drying, stripping drying, vacuum drying, natural drying, and adsorption drying.

6. A binder composition comprising polymer powder for a binder,
wherein the polymer powder includes two or more blocks and has an average particle size of 1 to 50 μm, and when the polymer powder is subjected to dry mixing with a particulate material, polymer particles dissociate and bind to at least a portion of the surface of the particulate material.

7. The binder composition of claim 6, wherein the polymer is a block copolymer including a structural unit derived from an aromatic vinyl monomer and a structural unit derived from a conjugated diene-based monomer.

8. The binder composition of claim 7, wherein the structural unit derived from the aromatic vinyl monomer is included in an amount of 10 to 50 parts by weight based on 100 parts by weight of the polymer.

9. The binder composition of claim 6, wherein the polymer has a weight average molecular weight of 5,000 to 2,000,000 g/mol.

10. The binder composition of claim 6, wherein the polymer is a linear polymer.

11. The binder composition of claim 10, wherein the polymer has a degree of branching of 9 or less.

12. The binder composition of claim 6, wherein the composition does not include a solvent.
